(19) United States
(12) Patent Application Publication
(10) Pub. No.: US 2024/0283891 A1
(43) Pub. Date: Aug. 22, 2024

(54) INFORMATION PROCESSING METHOD, INFORMATION PROCESSING DEVICE, AND PROGRAM

(71) Applicant: NIPPON TELEGRAPH AND TELEPHONE CORPORATION, Tokyo (JP)

(72) Inventors: Daichi NAMIKAWA, Tokyo (JP); Kenya SUZUKI, Tokyo (JP); Taiji NAKAMURA, Tokyo (JP); Makoto MUTO, Tokyo (JP); Nobuhiro HIRACHI, Tokyo (JP); Seiichi KONYA, Tokyo (JP); Keisuke HASEGAWA, Tokyo (JP); Takashi MIYATAKE, Tokyo (JP)

(73) Assignee: NIPPON TELEGRAPH AND TELEPHONE CORPORATION, Tokyo (JP)

(21) Appl. No.: 18/568,331

(22) PCT Filed: Jun. 11, 2021
(86) PCT No.: PCT/JP2021/022391

§ 371 Date: Dec. 8, 2023

(51) Int. Cl. H04N 5/74; G03B 21/32

(52) U.S. Cl. CPC H04N 5/74; G03B 21/32

(57) ABSTRACT

An information processing method executed by a control unit included in an information processing device includes: a step of acquiring a video including an image of a region occupied by a subject, the image being extracted from a captured image obtained by capturing the subject; a step of deciding, by a first decision method, a first projection surface as a projection surface on which the video is to be displayed from among a plurality of projection surfaces; a step of deciding, by a second decision method, a second projection surface as a projection surface on which the video is to be displayed from among the plurality of projection surfaces; a step of deciding a display projection surface as a projection surface on which the video is to be displayed from among the plurality of projection surfaces on the basis of the first projection surface decided by the first decision method and the second projection surface decided by the second decision method; and a step of causing the video to be projected on the decided display projection surface.

### TECHNICAL FIELD

The present disclosure relates to an information processing method, an information processing device, and a program.

### BACKGROUND ART

There is known a pseudo hologram that performs holographic display in a pseudo manner by projecting a two-dimensional image on a projection surface such as a transparent or translucent screen, film, and plate, fog, and smoke (Non Patent Literature 1).

### CITATION LIST

### Non Patent Literature

Non Patent Literature 1: kajiguchi97, “Overview of aerial image and pseudo hologram”, Dec. 18, 2019, [Searched on May 28, 2021], Internet <URL:

https://kajiguchi97.hatenablog.com/entry/falseholograms>

### SUMMARY OF INVENTION

### Technical Problem

It is considered that a video of a game of a sport such as badminton, volleyball, table tennis, and tennis (hereinafter, referred to as a “net-type sport”) is projected and displayed on a projection surface of a pseudo hologram. In the net-type sport, players alternately send out a sphere or an object similar to a sphere (for example, a shuttle (shuttlecock) or the like) in a court separated by a net, and compete for scores based on whether the sphere is returned. It is assumed that such a net-type ball game is captured from a position on one territory side of the court, at which the entire court is overlooked, and the captured video is projected in a direction similar to the capturing direction, so that an image is formed on the projection surface. In such a case, when the players on the court are projected on the same projection surface, information in the depth direction may not be reflected in the video, and the players may be displayed in an overlapping manner. Therefore, the holographic display is not established, and an observer does not recognize a stereoscopic effect.

Therefore, it is conceivable to prepare two projection surfaces on the front side and the back side as viewed from the observer, and display an image of the player on the front half of the court, as viewed from the capturing position, on the front projection surface and an image of the player on the back half of the court on the back projection surface. In a case where such display is performed, the images of the players are displayed on the projection surfaces reflecting the positions of the players, so that a more realistic depth feeling can be obtained. Meanwhile, in the net-type ball game, the sphere or similar object goes between the front half of the court and the back half of the court according to the progress of the game. Therefore, it is necessary to project an image of the sphere or the like on either the front projection surface or the back projection surface so as not to cause a sense of discomfort as viewed from the observer.

An object of the present disclosure is to provide an information processing method, an information processing device, and a program capable of appropriately displaying an image of a subject such as a sphere or an object similar to a sphere on any projection surface in a projection system including a plurality of projection surfaces.

### Solution to Problem

An information processing method according to an embodiment is an information processing method executed by a control unit included in an information processing device, and the information processing method includes: a step of acquiring a video including an image of a region occupied by a subject, the image being extracted from a captured image obtained by capturing the subject; a step of deciding, by a first decision method, a first projection surface as a projection surface on which the video is to be displayed from among a plurality of projection surfaces; a step of deciding, by a second decision method, a second projection surface as a projection surface on which the video is to be displayed from among the plurality of projection surfaces; a step of deciding a display projection surface as a projection surface on which the video is to be displayed from among the plurality of projection surfaces on the basis of the first projection surface decided by the first decision method and the second projection surface decided by the second decision method; and a step of causing the video to be projected on the decided display projection surface.

An information processing device according to an embodiment includes a control unit configured to: acquire a video including an image of a region occupied by a subject, the image being extracted from a captured image obtained by capturing the subject; decide, by a first decision method, a first projection surface as a projection surface on which the video is to be displayed from among a plurality of projection surfaces; decide, by a second decision method, a second projection surface as a projection surface on which the video is to be displayed from among the plurality of projection surfaces; decide a display projection surface as a projection surface on which the video is to be displayed from among the plurality of projection surfaces on the basis of the first projection surface decided by the first decision method and the second projection surface decided by the second decision method; and cause the video to be projected on the decided display projection surface.

A program according to an embodiment causes a computer to execute the above-described information processing method.

### Advantageous Effects of Invention

According to an embodiment of the present disclosure, in a projection system including a plurality of projection surfaces, an image of a subject such as a sphere or an object similar to a sphere can be appropriately displayed on any of the projection surfaces.

### BRIEF DESCRIPTION OF DRAWINGS

FIG. 1 is a block diagram illustrating a functional configuration example of a projection system according to an embodiment.

FIG. 2 is a diagram schematically illustrating projection by the projection system in FIG. 1.

FIG. 3 is a diagram illustrating an example of contents of a projection position instruction.

FIG. 4 is a block diagram illustrating a functional configuration example of a mediation unit in FIG. 1.

FIG. 5A is a diagram illustrating an example of information in a projection position dictionary.

FIG. 5B is a diagram illustrating an example of information in the projection position dictionary.

FIG. 5C is a diagram illustrating an example of information in the projection position dictionary.

FIG. 6 is a diagram illustrating an example of a projection position instruction output by the mediation unit.

FIG. 7 is a diagram illustrating an example of a projection position instruction output by the mediation unit.

FIG. 8 is a block diagram illustrating a hardware configuration example of a mediation device in FIG. 1.

FIG. 9 is a flowchart illustrating an example of operation of mediation processing.

FIG. 10 is a flowchart illustrating an example of the operation of the mediation processing.

FIG. 11 is a flowchart illustrating an example of the operation of the mediation processing.

### DESCRIPTION OF EMBODIMENTS

Hereinafter, an embodiment of the present disclosure will be described with reference to the drawings. In the drawings, parts having the same configuration or function are denoted by the same reference signs. In the description of the present embodiment, redundant description of the same parts may be omitted or simplified as appropriate.

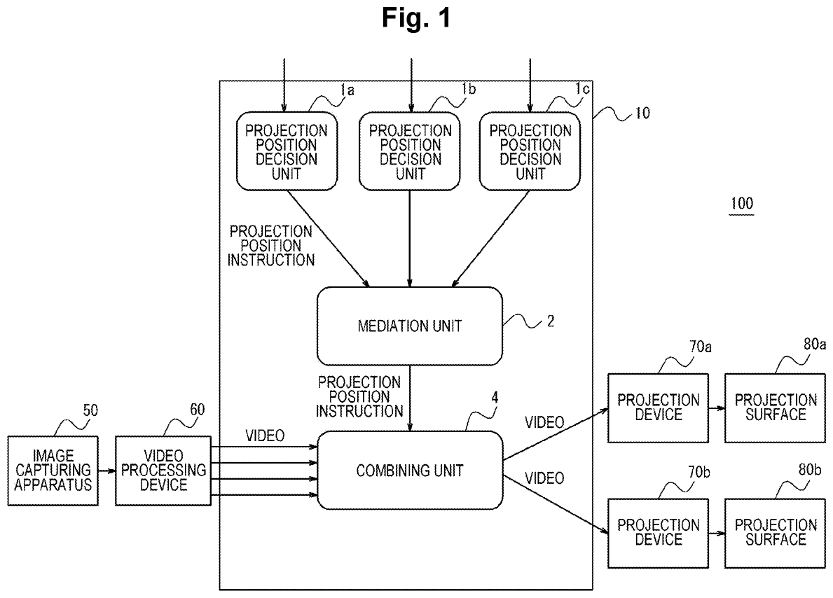

FIG. 1 is a block diagram illustrating a functional configuration example of a projection system 100 according to the embodiment. The projection system 100 includes a mediation device 10, an image capturing apparatus 50, a video processing device 60, a plurality of projection devices 70 (70a and 70b), and a plurality of projection surfaces 80 (80a and 80b). In the present embodiment, as an example, a configuration will be described in which two projection devices 70a and 70b and two projection surfaces 80a and 80b are provided, but three or more projection devices 70 and projection surfaces 80 may be provided.

The image capturing apparatus 50 captures a subject and outputs a video. As an example, the image capturing apparatus 50 according to the present embodiment captures a video of a game of a net-type sport such as badminton, volleyball, table tennis, and tennis from a position on one territory side of a court, at which the entire court is overlooked. The capturing position and the capturing direction of the image capturing apparatus 50 are decided in advance such that the captured video makes it easy to grasp the entire game and allows the depth of the entire court to be viewed at an angle of view and an angle that are often used for a game broadcast or the like. The video captured by the image capturing apparatus 50 includes images of players of the net-type sport and a sphere or an object similar to a sphere. Hereinafter, an example of a case will be described where the image capturing apparatus 50 captures a video of a badminton game (singles competition) in which two players alternately send out a shuttle as a subject via rackets in a court separated by a net. The image capturing apparatus 50 includes an image capturing device that converts an input optical signal into an electrical signal to acquire an image. The image capturing apparatus 50 sequentially acquires a plurality of still images at a constant frame rate, and outputs the still images as video (moving image) data to the video processing device 60.

The video processing device 60 extracts image regions occupied by the players (including the rackets) and the shuttle from the video data input from the image capturing apparatus 50 using an image processing technology. The video processing device 60 may extract the image regions occupied by the players and the shuttle on the basis of, for example, the magnitude of variations in pixel value between preceding and following frames. At this time, the video processing device 60 may identify whether an extracted region corresponds to the players or corresponds to the shuttle, using information such as the size and luminance of the extracted region, for example. The video processing device 60 outputs, to the mediation device 10, each piece of the video data including the videos of the players, which include the extracted images of the players, and the video including the images of the shuttle. The video processing device 60 is implemented by, for example, a general-purpose information processing device such as a personal computer (PC) or a work station (WS), but may be implemented by a dedicated image processing device instead of the general-purpose information processing device.

The mediation device 10 serving as an information processing device according to the present embodiment combines the video of the shuttle as a subject with either the video of the player on the front side or the video of the player on the back side as viewed from the image capturing apparatus 50. Among the two videos of the players, either of which the video of the shuttle is combined with, the video data of the video of the player on the front side is output to the projection device 70a, and the video data of the video of the player on the back side is output to the projection device 70b. Details of the configuration of the mediation device 10 will be described later.

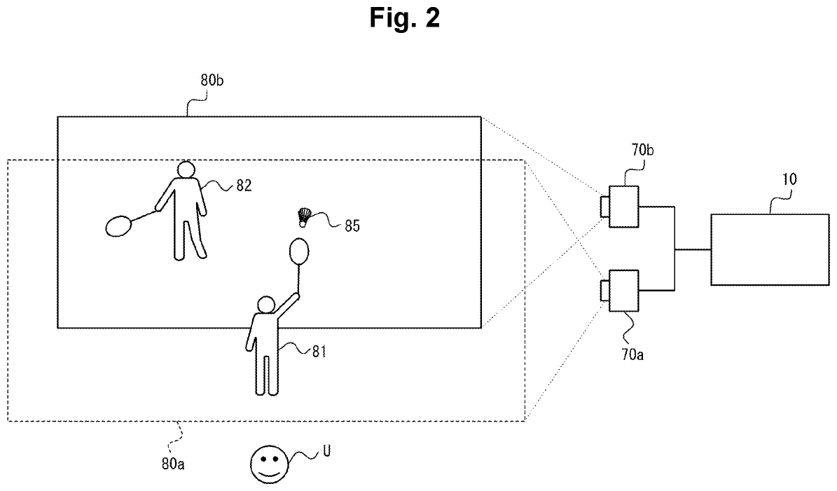

The projection devices 70 (70a and 70b) and the projection surfaces 80 (80a and 80b) display the images by a known pseudo hologram technology such as a Pepper's ghost, a recursive transmission optical element, or a fog/smoke screen. FIG. 2 is a diagram schematically illustrating projection by the projection system 100 in FIG. 1.

The projection devices 70 (70a and 70b) generate videos of light on the basis of the video data input from the mediation device 10 and project the videos of light on the projection surfaces 80 (80a and 80b). The projection device 70a projects a video of the video data input from the mediation device 10 on the projection surface 80a. The projection device 70b projects a video of the video data input from the mediation device 10 on the projection surface 80b. Each of the projection devices 70 (70a and 70b) may be configured by a projector adopting any projection method. Such a projection method may include, for example, a cathode ray tube (CRT) method, a liquid crystal display (LCD) method, a liquid crystal on silicon (LCoS) method, a digital light processing (DLP) method, a grating light valve (GLV) method, and the like.

The projection devices 70 (70a and 70b) project the videos, so that the visible images are displayed on the projection surfaces 80 (80a and 80b). The projection surface 80a is a projection surface provided on the front side as viewed from an observer U. The projection surface 80b is a projection surface provided on the back side of the projection surface 80a as viewed from the observer U. Each of the projection surfaces 80 (80a and 80b) may be constituted by a transparent or translucent screen, film, and plate, fog, smoke, and the like. In the present embodiment, as an example, each of the projection surfaces 80 (80a and 80b) is implemented by a transparent screen.

In the example of FIG. 2, an image 81 occupied by the player on the front side as viewed from the image capturing apparatus 50 and an image 85 occupied by the shuttle as a subject are displayed on the front projection surface 80a as viewed from the observer U. An image 82 occupied by the player on the back side as viewed from the image capturing apparatus 50 is displayed on the back projection surface 80b. The projection surfaces 80 (80a and 80b) may be provided, for example, on a court with a net in a place different from the court in which the badminton game is being played, and may be arranged so as to display images that appear similar to the real players and shuttle as viewed from the image capturing apparatus 50 when the displayed images are viewed from the observer U at a certain position. According to such a configuration, it is possible to reproduce a state of a badminton game performed at a certain place on another court with realistic feeling.

However, in the net-type sport such as badminton, a sphere or an object similar to a sphere (shuttle or the like) as a subject goes between the front half of the court and the back half of the court according to the progress of the game. Therefore, it is necessary to decide on which of the front projection surface 80a and the back projection surface 80b the image of the sphere or the like is to be projected according to the progress of the game. In the present embodiment, the mediation device 10 decides one of the projection surfaces 80 (80a and 80b) on which the shuttle is to be displayed, by combining a plurality of methods. Therefore, according to the mediation device 10, it is possible to appropriately decide on which of the front projection surface 80a and the back projection surface 80b the sphere or similar object is to be displayed and to display the sphere or similar object. Therefore, the shuttle moves back and forth between the two projection surfaces on the front side and the back side in a form that does not give the observer U a sense of discomfort, and the user experience can be improved.

In FIG. 1, the mediation device 10 as the information processing device according to the present embodiment includes a plurality of projection position decision units 1 (1a, 1b, and 1c), a mediation unit 2, and a combining unit 4.

Each of the plurality of projection position decision units 1 (1a, 1b, and 1c) decides a projection surface on which the video of the subject (shuttle) is to be displayed from among the plurality of projection surfaces 80 (80a and 80b) by a predetermined method. In the present embodiment, each of the plurality of projection surfaces 80 (80a and 80b) is associated in advance with a space occupying a certain region. For example, a space on the front side of a fence of the competition site as viewed from the image capturing apparatus 50 may be associated with the front projection surface 80a, and a space on the back side may be associated with the back projection surface 80b. Each of the projection position decision units 1 (1a, 1b, and 1c) may determine the space in which the shuttle is present by a predetermined determination method, and decide one of the projection surfaces 80 (80a and 80b) corresponding to the determined space as a projection surface on which the video of the shuttle is to be displayed. Specifically, the methods for deciding the projection surface 80 may include, for example, the following methods.
Method a: A method in which a captured image acquired by at least one image capturing apparatus provided in the game venue is analyzed to determine whether the shuttle is located on the front half of the court or the back half of the court as viewed from the image capturing apparatus 50, and the projection surface 80 is decided according to the result.
Method b: A method in which a captured image acquired by at least one image capturing apparatus provided in the game venue is analyzed to determine the movement of the players and the rackets, and the projection surface 80 is decided according to the result.
Method c: A method in which a hitting sound of the shuttle acquired by at least one microphone provided in the game venue is analyzed to determine whether the shuttle is located on the front half of the court or the back half of the court as viewed from the image capturing apparatus 50, and the projection surface 80 is decided according to the result.
Method d: A method in which the projection surface 80 is decided according to a detection result of at least one dedicated sensor for detecting the position of the shuttle provided in the game venue.
Method e: A method in which a person observing the game manually decides the projection surface 80.

The methods described here are examples of a method for deciding the projection surface 80, and the projection position decision units 1 may decide the projection surface 80 using any method. Furthermore, in the example of FIG. 1, the mediation device 10 is provided with three projection position decision units 1a, 1b, and 1c as the plurality of projection position decision units 1, but two or four or more projection position decision units 1 may be provided.

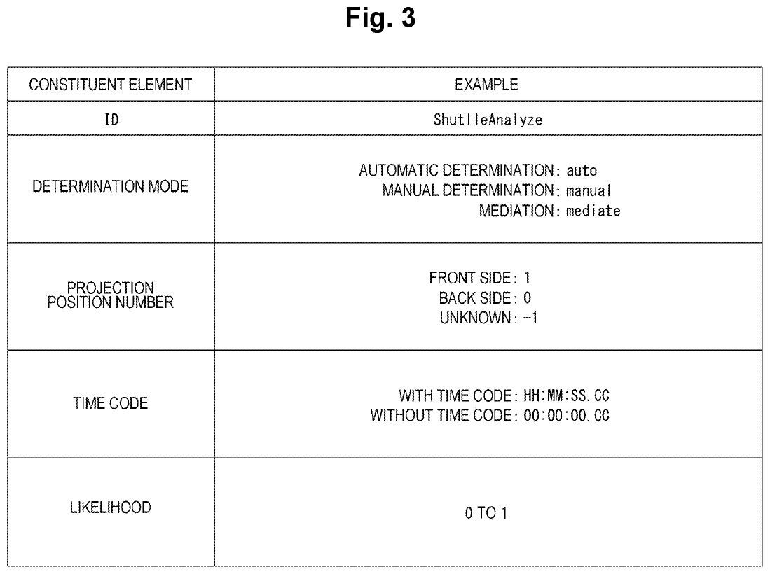

Each of the plurality of projection position decision units 1 (1a, 1b, and 1c) outputs a result of decision of the projection surface 80 by information called a projection position instruction. FIG. 3 is a diagram illustrating an example of contents of a projection position instruction. As illustrated in FIG. 3, the projection position instruction includes an ID, a determination mode, a projection position number, a time code, and a likelihood.

The “ID” is identification information of the projection position instruction. In the example of FIG. 3, identification information “ShuttleAnalyze” is indicated. For example, “ShuttleAnalyze” may indicate a projection position instruction output from the projection position decision unit 1a.

The “determination mode” is information indicating the type of a method for deciding the projection surface 80. In the present embodiment, the type of a method for deciding the projection surface 80 is classified into one of automatic determination (auto), manual determination (manual), and mediation (mediate). The “automatic determination (auto)” is a method that does not involve human evaluation. Among the foregoing methods a to e, the methods a to d correspond to the “automatic determination (auto)” methods. The “manual determination (manual)” is a method involving human evaluation. Among the foregoing methods a to e, the method e corresponds to the “manual determination (manual)” method. The “mediation (mediate)” indicates a method decided by the mediation unit 2. Either the “automatic determination (auto)” or the “manual determination (manual)” is set in the “determination mode” of a projection position instruction output from each of the projection position decision units 1 (1a, 1b, and 1c).

The “projection position number” is information for identifying the decided projection surface 80 (80a or 80b). In the example of FIG. 3, “1” indicates the projection surface 80a on the front side, “0” indicates the projection surface 80b on the back side, and “−1” indicates that the projection surface cannot be decided (unknown).

The “time code” is information indicating a temporal position in the video input from the video processing device 60. The “time code” may be, for example, a time at which the video is captured, a time elapsed from the start of capturing of the video to capturing of the image to be processed, or a time at which the projection position decision unit 1 performs processing.

The “likelihood” is an index indicating the degree of certainty that the shuttle is actually present in the space decided by a predetermined determination method. In the present embodiment, the “likelihood” is set to a value of 0 to 1. For example, in a case where the space in which the shuttle is present is determined by at least one dedicated sensor for detecting the position of the shuttle provided in the game venue, it is considered that the certainty of the determination result is high. Therefore, the likelihood of position indication information generated on the basis of such a determination result may be set to a large value. Meanwhile, in a case where the space in which the shuttle is present is determined manually, it is considered that the certainty of the determination result is not high. Therefore, the likelihood of position indication information generated on the basis of such a determination result may be set to a small value. Furthermore, each of the plurality of projection position decision units 1 (1a, 1b, and 1c) may adjust the likelihood according to the accuracy of information used for the determination even in a case where the same determination method is used as a determination method for determining the space in which the shuttle is present. For example, in a case where the space in which the shuttle is present is determined by the method c based on a hitting sound of the shuttle, a larger likelihood may be set when a larger hitting sound is acquired, and a smaller likelihood may be set when a smaller hitting sound is acquired.

Each of the projection position decision units 1 (1a, 1b, and 1c) decides the projection surface 80 at a constant sampling rate (for example, once every 0.1 seconds), and outputs a projection position instruction having information as described above to the mediation unit 2. The projection position instructions output from the projection position decision units 1 (1a, 1b, and 1c) may be output by push type communication based on a communication protocol such as Open Sound Control (OSC) or WebSocket, for example.

The mediation unit 2 mediates the projection position instructions received from the projection position decision units 1 (1a, 1b, and 1c), and decides a display projection surface as a projection surface on which the video is to be displayed. The mediation unit 2 outputs a projection position instruction indicating the decided display projection surface to the combining unit 4.

On the basis of the input projection position instruction, the combining unit 4 combines the video of the shuttle as a subject with one of the video of the player on the front side and the video of the player on the back side. Among the two videos of the players, either of which the video of the shuttle is combined with, the combining unit 4 outputs the video data of the video of the player on the front side to the projection device 70a, and outputs the video data of the video of the player on the back side to the projection device 70b. In this manner, the combining unit 4 causes the projection devices 70 to project the video including the shuttle as a subject on the decided display projection surface.

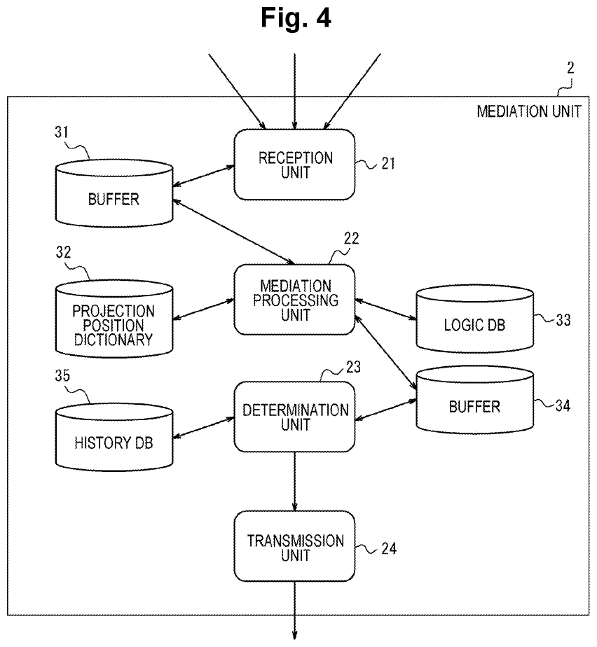

A detailed configuration of the mediation unit 2 will be described with reference to FIG. 4. FIG. 4 is a block diagram illustrating a functional configuration example of the mediation unit 2 in FIG. 1. As illustrated in FIG. 4, the mediation unit 2 includes a reception unit 21, a mediation processing unit 22, a determination unit 23, a transmission unit 24, a buffer 31, a projection position dictionary 32, a logic DB 33, a buffer 34, and a history DB 35.

The reception unit 21 receives the projection position instructions output from the projection position decision units 1 (1a, 1b, and 1c). The reception unit 21 causes the buffer 31 to hold each of the received projection position instructions. The buffer 31 is a storage area that holds the projection position instructions received by the reception unit 21.

The mediation processing unit 22 temporarily stores each of the plurality of projection position instructions stored in the buffer 31 in the projection position dictionary 32 after adding weight information. Furthermore, the mediation processing unit 22 generates one projection position instruction on the basis of the plurality of projection position instructions temporarily stored in the projection position dictionary 32, on the basis of logic (rules) stored in the logic database (DB) 33 in advance, and stores the generated one projection position instruction in the buffer 34.

The projection position dictionary 32 is dictionary data that temporarily stores the weighted projection position instructions, and is provided in a storage area. The logic DB 33 is a database that stores logic by which the mediation processing unit 22 generates one projection position instruction on the basis of the plurality of projection position instructions. The buffer 34 is a storage area that stores the projection position instruction generated by the mediation processing unit 22.

The determination unit 23 determines whether there is a problem in transmitting the projection position instruction stored in the buffer 34 to the combining unit 4 on the basis of information in the history DB 35. In a case where it is determined that there is no problem, the determination unit 23 outputs the projection position instruction to the transmission unit 24 at a designated time, and stores the result in the history DB 35. The history DB 35 is a database that stores “projection position numbers” of projection position instructions transmitted in the past. The transmission unit 24 transmits the projection position instruction output from the determination unit 23 to the combining unit 4.

The reception unit 21 receives the projection position instructions output from the plurality of projection position decision units 1. Communication at this time may be performed on the basis of a communication protocol such as OSC or WebSocket. The reception unit 21 stores the received projection position instructions in time series in the buffer 31. The buffer 31 may include, for example, a general relational database.

The mediation processing unit 22 refers to the time codes of the projection position instructions stored in the buffer 31 to acquire projection position instructions in a specific time zone. The mediation device 10 may allow a user to designate a time width (for example, 0.3 seconds) of each projection position instruction acquired by the mediation processing unit 22 from the buffer 31.

The mediation processing unit 22 writes information on the acquired projection position instructions in the projection position dictionary 32 using the IDs as keys, and further adds weight information to each projection position instruction. In the present embodiment, the same predetermined value as a weight is added to all the projection position instructions. However, the weight may be set to a different value for each of the projection position decision units 1 (1a, 1b, and 1c) according to the type of a method for deciding the projection surface 80, which is adopted in each of the projection position decision units 1 (1a, 1b, and 1c) that have output the projection position instructions.

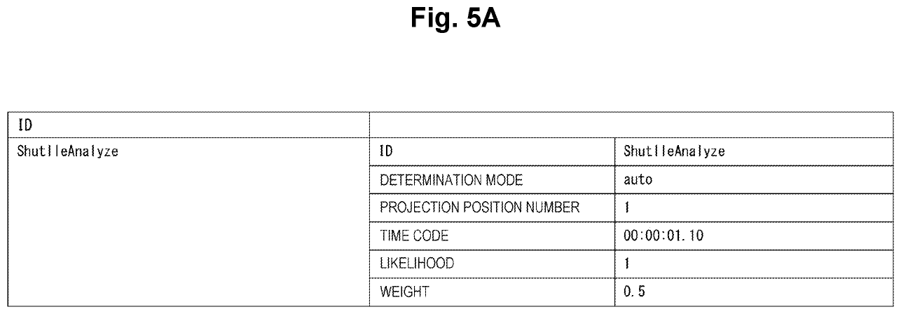

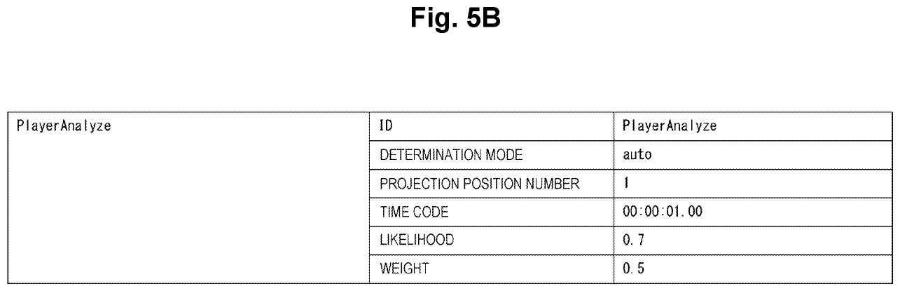

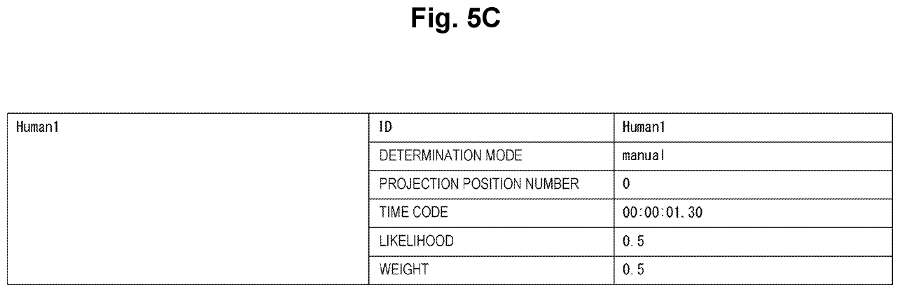

FIGS. 5A to 5C are diagrams illustrating examples of information in the projection position dictionary 32. In each of the projection position instructions in FIGS. 5A to 5C, “0.5” is added as a “weight”. In the projection position instruction in FIG. 5A, “ShuttleAnalyze” is set in the “ID”, “auto” is set in the “determination mode”, “1” is set in the “projection position number”, “00:00:01.10” is set in the “time code”, and “1” is set in the “likelihood”. In the projection position instruction in FIG. 5B, “PlayerAnalyze” is set in the “ID”, “auto” is set in the “determination mode”, “1” is set in the “projection position number”, “00:00:01.00” is set in the “time code”, and “0.7” is set in the “likelihood”. In the projection position instruction in FIG. 5C, “Human1” is set in the “ID”, “manual” is set in the “determination mode”, “0” is set in the “projection position number”, “00:00:01.30” is set in the “time code”, and “0.5” is set in the “likelihood”.

The mediation processing unit 22 decides the projection surface 80 on which the video of the shuttle is to be projected on the basis of the information stored in the projection position dictionary 32 and the logic stored in the logic DB 33, and creates a projection position instruction. The logic stored in the logic DB 33 includes, for example, information on “elements of projection position instructions used for decision of the projection surface 80” and a “method for deciding the projection surface 80 on the basis of the elements of the projection position instructions”. Hereinafter, an example will be described in which the mediation processing unit 22 changes the “weight” of a projection position instruction stored in the projection position dictionary 32 on the basis of the logic in the logic DB 33 and decides the projection surface 80 on the basis of the changed “weight”.

For example, the logic in the logic DB 33 may focus on the “determination mode” and the “projection position number” as “elements of projection position instructions used for decision of the projection surface 80”. On this basis, the “method for deciding the projection surface 80 on the basis of the elements of the projection position instructions” may be as follows. That is,
(1) for each of the projection position instructions stored in the projection position dictionary 32, the weight of a projection position instruction whose determination mode is “auto” is changed to “1”, and the weight of a projection position instruction whose determination mode is “manual” is changed to “0.5”.
(2) Furthermore, the weights of the projection position instructions stored in the projection position dictionary 32 are added for each of the plurality of projection surfaces 80 (80a and 80b), and the projection surface 80 having the largest total value of the weights is decided as a display projection surface on which the video of the shuttle is to be displayed.

Such a decision method is an example of a method of preferentially deciding, as a display projection surface, the projection surface 80 corresponding to a space determined by a method not involving human evaluation.

In a case where the projection position instructions stored in the projection position dictionary 32 are those illustrated in FIGS. 5A to 5C, and the mediation processing unit 22 applies such logic, the following processing is performed. That is, in each of the projection position instruction with the “ID” of “ShuttleAnalyze” (FIG. 5A) and the projection position instruction with the “ID” of “PlayerAnalyze” (FIG. 5B), the “determination mode” is “auto”, and thus the “weight” is changed to “1”. In the projection position instruction with the “ID” of “Human1” (FIG. 5C), the “determination mode” is “manual”, and thus the “weight” is changed to “0.5”. The “IDs” of the projection position instructions with the “projection position number” of “1” (the projection surface 80a on the front side) are “ShuttleAnalyze” and “PlayerAnalyze”, and the total value of the “weights” of these projection position instructions is “2”. The “ID” of the projection position instruction with the “projection position number” of “0” (the projection surface 80b on the back side) is “Human1”, and the total value of the “weight” of this projection position instruction is “0.5”. Therefore, the projection surface 80 having the largest total value of the weights is the projection surface 80a, and thus the mediation processing unit 22 decides the projection surface 80a as a display projection surface on which the video of the shuttle is to be displayed.

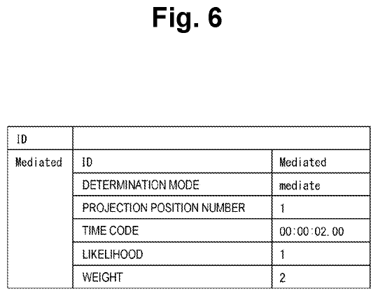

As a result of the mediation, the mediation processing unit 22 generates a projection position instruction in which “1” is set in the “projection position number”. FIG. 6 is a diagram illustrating an example of a projection position instruction output by such processing. As illustrated in FIG. 6, in the “determination mode” of the projection position instruction output as a result of the mediation, “mediated” is described. As a value of each of the elements other than the “projection position number” and the “determination mode”, an initial value, a current time, or the like may be set.

Furthermore, the logic of the logic DB 33 may focus on the “projection position number”, the “likelihood”, and the “weight” as “elements of projection position instructions used for decision of the projection surface 80”. On this basis, the “method for deciding the projection surface 80 on the basis of the elements of the projection position instructions” may be as follows. That is
(1) for each of the projection position instructions stored in the projection position dictionary 32, the “likelihood” and the “weight” are multiplied together, and the value of the “weight” is changed according to the value of the multiplied result.
(2) The projection surface 80 indicated by the “projection position number” of the projection position instruction having the largest value of the changed “weight” is decided as a display projection surface on which the video of the shuttle is to be displayed.

As described above, in the present embodiment, the same value (0.5) as a “weight” is set to all the projection position instructions. Therefore, such a decision method is an example of a method of deciding the display projection surface on the basis of the degree of certainty (likelihood) that the shuttle as a subject is present in a space.

When the mediation processing unit 22 applies such logic to the projection position instructions illustrated in FIGS. 5A to 5C, the following processing is performed. That is, in the projection position instruction with the “ID” of “ShuttleAnalyze” (FIG. 5A) , the “likelihood” is “1”, the “weight” is “0.5”, and thus the “weight” is changed to 1×0.5=0.5. In the projection position instruction with the “ID” of “PlayerAnalyze” (FIG. 5B) , the “likelihood” is “0.7”, the “weight” is “0.5”, and thus the “weight” is changed to 0.7×0.5=0.35. In the projection position instruction with the “ID” of “Human1” (FIG. 5C) , the “likelihood” is “0.5”, the “weight” is “0.5”, and thus the “weight” is changed to 0.5×0.5=0.25. As a result of such processing, the “ID” of the projection position instruction having the largest value of the changed “weight” is “ShuttleAnalyze” whose “weight” is 0.5. The “projection position number” of “ShuttleAnalyze” is “1”, and thus the mediation processing unit 22 decides the projection surface 80a as a display projection surface on which the video of the shuttle is to be displayed.

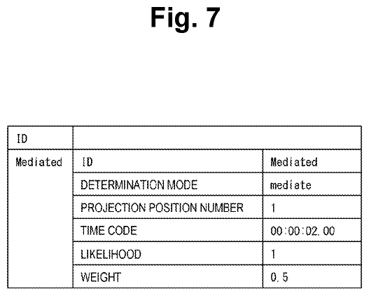

As a result of the mediation, the mediation processing unit 22 generates a projection position instruction in which “1” is set in the “projection position number”. FIG. 7 is a diagram illustrating an example of a projection position instruction output by such processing. As in FIG. 6, as a value of each of the elements other than the “projection position number” and the “determination mode”, an initial value, a current time, or the like may be set.

Next, the mediation processing unit 22 stores the generated projection position instruction in the buffer 34.

The determination unit 23 takes out the projection position instruction from the buffer 34, and determines whether there is a problem in passing the projection position instruction to the transmission unit 24 on the basis of the projection position instruction and information on past projection position instructions stored in the history DB 35. For example, when the projection surface 80 displaying the image 85 of the shuttle is switched in a very short time, the depth of the shuttle is changed at a high speed, and thus the visibility of the image 85 of the shuttle is very poor for the observer U. Therefore, in a case where a projection position instruction for switching the projection surface 80 is input within a certain period of time after the projection surface 80 is switched, the determination unit 23 may determine not to pass the projection position instruction to the transmission unit 24. Furthermore, in a case where an “ID” or a “determination mode” of a projection position instruction that is not desirably followed as it is from the viewpoint of maintaining realistic feeling of the game is known, the determination unit 23 may determine not to pass a projection position instruction having the “ID” or the “determination mode” to the transmission unit 24. The determination unit 23 outputs the projection position instruction determined to have no problem to the transmission unit 24, and stores, as history information, the “projection position number” of the projection position instruction in the history DB 35.

The transmission unit 24 transmits the projection position instruction passed from the determination unit 23 to the combining unit 4. The transmission unit 24 may transmit the projection position instruction to the combining unit 4 after delaying the projection position instruction by a predetermined delay amount, in order to synchronize with the video input from the video processing device 60.

As described above, the mediation device 10 acquires a video including an image of a region occupied by a subject such as a sphere or an object similar to a sphere, which is extracted from a captured image obtained by capturing the subject. The mediation device 10 decides first and second projection surfaces as projection surfaces on which the video of the subject is to be displayed from among a plurality of projection surfaces by first and second decision methods. On the basis of the first projection surface decided by the first decision method and the second projection surface decided by the second decision method, the mediation device 10 decides a display projection surface as a projection surface on which the video is to be displayed from among the plurality of projection surfaces, and causes the video to be projected on the display projection surface. Therefore, in the present embodiment, the plurality of methods for deciding the projection surface on which the video of the subject is to be displayed from among the plurality of projection surfaces is combined to decide the display projection surface, and thus it is possible to appropriately display the image of the subject such as the sphere or similar object on any of the projection surfaces.

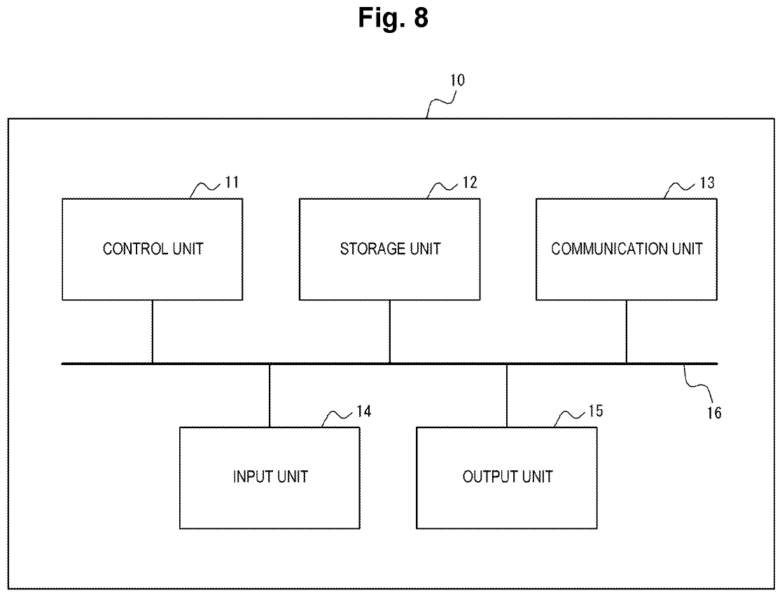

The mediation device 10 is implemented by a general-purpose information processing device such as a PC or a WS. FIG. 8 is a block diagram illustrating a hardware configuration example of the mediation device 10 in FIG. 1. As illustrated in FIG. 8, the mediation device 10 includes a control unit 11, a storage unit 12, a communication unit 13, an input unit 14, an output unit 15, and a bus 16.

The control unit 11 is communicably connected to each of the components constituting the mediation device 10 via the bus 16, and controls the operation of the entire mediation device 10. The control unit 11 includes one or more processors. In the embodiment, the “processor” is a general-purpose processor or a dedicated processor specialized for specific processing, but is not limited thereto. The processor may be, for example, a central processing unit (CPU), a graphics processing unit (GPU), a digital signal processor (DSP), an application specific integrated circuit (ASIC), or a combination thereof.

The storage unit 12 stores any information used for the operation of the mediation device 10. For example, the storage unit 12 may store a system program, an application program, and various types of information received by the communication unit 13. The storage unit 12 includes any storage module including a hard disk drive (HDD), a solid state drive (SSD), a random access memory (RAM), a read-only memory (ROM), an electrically erasable programmable ROM (EEPROM), or a combination thereof. The storage unit 12 may function as, for example, a main storage device, an auxiliary storage device, or a cache memory. The storage unit 12 is not limited to a storage unit built in the mediation device 10, and may be an external database or an external storage module connected by a digital input/output port or the like such as a universal serial bus (USB). The buffer 31, the projection position dictionary 32, the logic DB 33, the buffer 34, and the history DB 35 described above are implemented by the storage unit 12.

The communication unit 13 functions as an interface for communicating with another device such as the mediation device 10. The communication unit 13 includes any communication module communicably connectable to another device by any communication technology including a wired local area network (LAN), a wireless LAN, and the like. The communication unit 13 may further include a communication control module for controlling communication with another device and a storage module for storing communication data such as identification information necessary for communication with another device.

The input unit 14 includes one or more input interfaces that receive a user's input operation and acquire input information based on the user's operation. For example, the input unit 14 is a physical key, a capacitance key, a pointing device, a touch screen provided integrally with a display of the output unit 15, a microphone that receives voice input, or the like, but is not limited thereto.

The output unit 15 includes one or more output interfaces that output information to a user to notify the user of the information. For example, the output unit 15 is a display that outputs information as an image, a speaker that outputs information as a sound, or the like, but is not limited thereto. Note that at least one of the input unit 14 and the output unit 15 described above may be configured integrally with the mediation device 10 or may be provided separately.

The functions of the mediation device 10 are implemented by the processor included in the control unit 11 executing a program according to the present embodiment. That is, the functions of the mediation device 10 are implemented by software. The program causes a computer to execute processing of steps included in the operation of the mediation device 10, thereby causing the computer to implement the functions corresponding to the processing of the steps. That is, the program is a program for causing the computer to function as the mediation device 10 according to the present embodiment. A program command may be a program code, a code segment, or the like for executing a necessary task.

The program may be recorded in a computer-readable recording medium. Using such a recording medium makes it possible to install the program in the computer. Here, the recording medium in which the program is recorded may be a non-transitory (non-temporary) recording medium. The non-transitory recording medium may be a compact disk ROM (CD-ROM), a digital versatile disc ROM (DVD-ROM), a Blu-ray (registered trademark) disk-ROM, or the like. In addition, the program may be distributed by being stored in a storage of an external device and transferred from the external device to another computer via a network. The program may be provided as a program product.

The computer temporarily stores, for example, the program recorded in a portable recording medium or the program transferred from an external device in the main storage device. The computer then reads the program stored in the main storage device by the processor, and executes processing according to the read program by the processor. The computer may read the program directly from the portable recording medium and execute processing according to the program. Each time the program is transferred from the external device to the computer, the computer may sequentially execute processing according to the received program. Such processing may be executed by a so-called application service provider (ASP) type service that implements a function only by an execution instruction and result acquisition without transferring the program from the external device to the computer. The program includes information that is used for processing by an electronic computer and is equivalent to the program. For example, data that is not a direct command to the computer but has a property that defines processing of the computer corresponds to “information equivalent to the program”.

Some or all of the functions of the mediation device 10 may be implemented by a dedicated circuit included in the control unit 11. That is, some or all of the functions of the mediation device 10 may be implemented by hardware. In addition, the mediation device 10 may be implemented by a single information processing device or may be implemented by cooperation of a plurality of information processing devices. Furthermore, at least one of the image capturing apparatus 50, the video processing device 60, and the projection devices 70 included in the projection system 100 may be implemented by the same device as the mediation device 10.

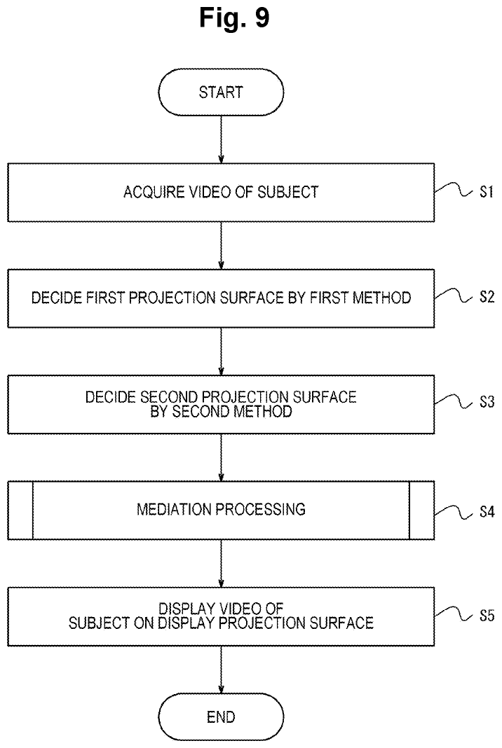

FIGS. 9 to 11 are flowcharts illustrating an example of operation of mediation processing executed by the mediation device 10. The operation of the mediation device 10 described with reference to FIGS. 9 to 11 corresponds to an information processing method according to the present embodiment. The operation of each step in FIGS. 9 to 11 is executed under the control of the control unit 11 of the mediation device 10. A program for causing a computer to execute the information processing method according to the present embodiment includes steps illustrated in FIGS. 9 to 11.

In step S1 of FIG. 9, the control unit 11 acquires a video including an image of a region occupied by a subject such as a shuttle, which is extracted from a captured image obtained by capturing the subject.

In step S2, the control unit 11 decides a first projection surface as a projection surface on which the video of the subject is to be displayed from among the plurality of projection surfaces 80 (80a and 80b) by a first decision method.

In step S3, the control unit 11 decides a second projection surface as a projection surface on which the video of the subject is to be displayed from among the plurality of projection surfaces 80 (80a and 80b) by a second decision method. Each of the first and second decision methods may be, for example, one of the foregoing methods a to e. In addition, as described above, each of the plurality of projection surfaces 80 (80a and 80b) is associated in advance with a space occupying a certain region. In steps S2 and S3, the space in which the subject is present may be determined by the first and second determination methods, and a projection surface corresponding to the determined space may be decided as the first projection surface or the second projection surface.

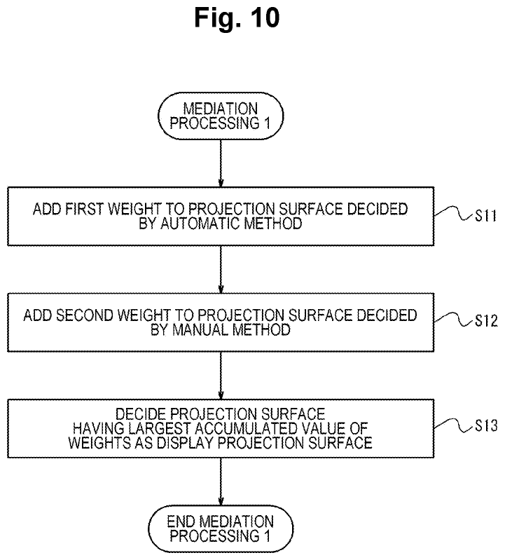

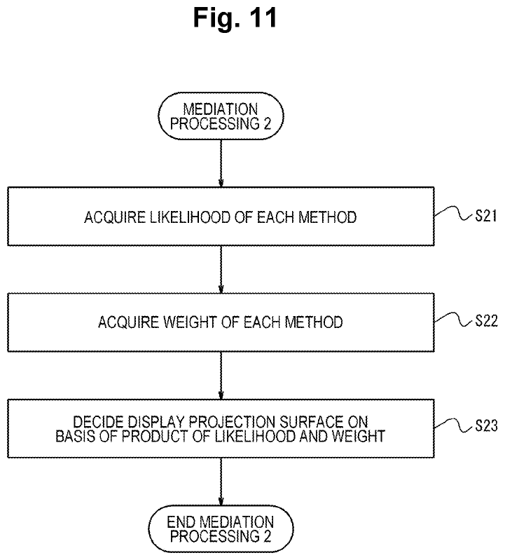

In step S4, the control unit 11 executes mediation processing of deciding a display projection surface as a projection surface on which the video of the subject is to be displayed from among the plurality of projection surfaces 80 on the basis of the first projection surface and the second projection surface. FIGS. 10 and 11 illustrate mediation processing 1 and mediation processing 2, which are examples of the mediation processing.

In the mediation processing 1 of FIG. 10, the projection surface 80 corresponding to a space determined by a method not involving human evaluation is preferentially decided as a display projection surface. In step S11 of FIG. 10, the control unit 11 adds a first weight to the projection surface 80 decided by an automatic method.

In step S12, the control unit 11 adds a second weight to the projection surface 80 decided by a manual method. Here, the second weight has a value smaller than the first weight.

In step S13, the control unit 11 calculates an accumulated value of weights for each of the plurality of projection surfaces 80 (80a and 80b), and decides the projection surface having the largest accumulated value as a display projection surface. When the processing of step S13 is completed, the control unit 11 proceeds to step S5 of FIG. 9.

In the mediation processing 2 of FIG. 11, the display projection surface is decided on the basis of the likelihood and the weight of each method for deciding the projection surface. In step S21 of FIG. 11, the control unit 11 acquires a first index (likelihood) indicating the degree of certainty that the subject is present in a space decided by the first determination method and a second index (likelihood) indicating the degree of certainty that the subject is present in a space decided by the second determination method.

In step S22, the control unit 11 acquires the weight of each method for deciding the projection surface.

In step S23, the control unit 11 calculates the product of the likelihood and the weight for each method for deciding the projection surface, and decides the display projection surface on the basis of the value. For example, the control unit 11 may decide, as a display projection surface, the projection surface 80 decided by the method having the largest product of the likelihood and the weight. In this case, when the same weight is assigned to all the determination methods as in the above-described example, the control unit 11 decides, as a display projection surface, the projection surface 80 corresponding to the space for which the index (likelihood) indicating the degree of certainty that the subject is present in the determined space is highest. Alternatively, the control unit 11 may calculate, for each of the projection surfaces 80, an accumulated value of products each calculated from the likelihood and the weight of a method for deciding the projection surface 80, and decide the projection surface 80 having the largest accumulated value as a display projection surface. When the processing of step S23 is completed, the control unit 11 proceeds to step S5 of FIG. 9.

The description returns to FIG. 9. In step S5, the control unit 11 causes the projection devices 70 to project the video of the subject on the display projection surface decided in step S4. The processing of the flowchart then ends.

As described above, in the configuration according to the present embodiment, the projection surface 80 on which a video of a shuttle is to be displayed is decided by a combination of a plurality of methods such as measurement of the three-dimensional position of the shuttle, motion analysis of players, analysis of a hitting sound of the shuttle, and manual setting by a human watching the game. As a result, the shuttle moves back and forth between the two projection surfaces 80 on the front side and the back side in a form that does not give the observer U a sense of discomfort, and the user experience can be improved.

The present disclosure is not limited to the embodiment described above. For example, a plurality of blocks in the block diagrams may be integrated, or one block may be divided. The plurality of steps in the flowcharts may be executed in parallel or in a different order depending on throughput of a device that executes each step or as necessary, instead of being chronologically executed according to the description. In addition, modifications can be made without departing from the gist of the present disclosure.

### REFERENCE SIGNS LIST

1 Projection position decision unit
2 Mediation unit
4 Combining unit
10 Mediation device
11 Control unit
12 Storage unit
13 Communication unit
14 Input unit
15 Output unit
16 Bus
21 Reception unit
22 Mediation processing unit
23 Determination unit
24 Transmission unit
31 Buffer
32 Projection position dictionary
33 Logic DB
34 Buffer
35 History DB
50 Image capturing apparatus
60 Video processing device
70 Projection device
80 Projection surface
81, 82 Image of player
85 Image of shuttle
100 Projection system
U Observer

1. An information processing method, comprising:
acquiring a video including an image of a region occupied by a subject, the image being extracted from a captured image obtained by capturing the subject;
deciding, by a first decision operation, a first projection surface as a projection surface on which the video is to be displayed from among a plurality of projection surfaces;
deciding, by a second decision operation, a second projection surface as a projection surface on which the video is to be displayed from among the plurality of projection surfaces;
deciding a display projection surface as a projection surface on which the video is to be displayed from among the plurality of projection surfaces on a basis of the first projection surface decided by the first decision operation and the second projection surface decided by the second decision operation; and
causing the video to be projected on the decided display projection surface.

2. The information processing method according to claim 1, wherein
each of the plurality of projection surfaces is associated in advance with a space occupying a certain region,
the deciding the first projection surface further comprises:
determining the space in which the subject is present by a first determination operation, and
deciding the projection surface corresponding to the determined space as the first projection surface, and
the deciding the second projection surface further comprises:
determining the space in which the subject is present by a second determination operation, and
deciding the projection surface corresponding to the determined space as the second projection surface.

3. The information processing method according to claim 2, wherein, the deciding the display projection surface further comprises:
determining the projection surface corresponding to the space without involving human evaluation in the first determination operation and the second determination operation.

4. The information processing method according to claim 2, further comprising:
acquiring a first index indicating a degree of certainty that the subject is present in the space decided by the first determination operation; and
acquiring a second index indicating a degree of certainty that the subject is present in the space decided by the second determination operation,
wherein the deciding the display projection surface further comprises deciding the display projection surface further on a basis of the first index and the second index.

5. The information processing method according to claim 4, wherein, the deciding the display projection surface further comprises:
deciding the projection surface corresponding to the space having a highest one of the degrees of certainty indicated by the first index and the second index as the display projection surface from among the first projection surface and the second projection surface.

6. An information processing device comprising a processor a processor configured to execute operations comprising:
acquiring a video including an image of a region occupied by a subject, the image being extracted from a captured image obtained by capturing the subject;
deciding, based on a first decision operation, a first projection surface as a projection surface on which the video is to be displayed from among a plurality of projection surfaces;
deciding, based on a second decision operation, a second projection surface as a projection surface on which the video is to be displayed from among the plurality of projection surfaces;
deciding a display projection surface as a projection surface on which the video is to be displayed from among the plurality of projection surfaces on a basis of the first projection surface decided by the first decision operation and the second projection surface decided by the second decision operation; and
cause the video to be projected on the decided display projection surface.

7. A computer-readable non-transitory recording medium storing a computer-executable program instructions that when executed by a processor cause a computer system to execute operations comprising:
acquiring a video including an image of a region occupied by a subject, the image being extracted from a captured image obtained by capturing the subject;
deciding, by a first decision operation, a first projection surface as a projection surface on which the video is to be displayed from among a plurality of projection surfaces;
deciding, by a second decision operation, a second projection surface as a projection surface on which the video is to be displayed from among the plurality of projection surfaces;
deciding a display projection surface as a projection surface on which the video is to be displayed from among the plurality of projection surfaces on a basis of the first projection surface decided by the first decision operation and the second projection surface decided by the second decision operation; and
causing the video to be projected on the decided display projection surface.

8. The information processing method according to claim 1, wherein the subject includes a sport player playing a sport.

9. The information processing method according to claim 1, wherein the first operation includes analyzing the image to determine whether a moving object is located in a front half of the region or a back half of the region as viewed from a position of capturing the image to decide the first projection surface, and the moving object is distinct from the subject.

10. The information processing method according to claim 1, wherein the first operation includes analyzing the image to determine movement of the subject and an object held by the subject to decide the first projection.

11. The information processing method according to claim 1, wherein the first operation includes analyzing a sound captured by a microphone in proximity of the region to determine whether the moving object is located in a front half of the region or a back half of the region as viewed from a position of capturing image to decide the first projection surface, the sound corresponds to hitting a moving object, and the moving object is distinct from the subject.

12. The information processing method according to claim 1, wherein the first operation includes deciding the first project surface according to a result of detecting a result of a sensor detecting a position of a moving object, wherein the moving object is distinct from the subject.

13. The information processing method according to claim 1, wherein the first operation includes a manual operation to decide the first project surface.

14. The information processing device according to claim 6, wherein
each of the plurality of projection surfaces is associated in advance with a space occupying a certain region,
the deciding the first projection surface further comprises:
determining the space in which the subject is present by a first determination operation, and
deciding the projection surface corresponding to the determined space as the first projection surface, and
the deciding the second projection surface further comprises:
determining the space in which the subject is present by a second determination operation, and
deciding the projection surface corresponding to the determined space as the second projection surface.

15. The information processing device according to claim 14, wherein, the deciding the display projection surface further comprises:
determining the projection surface corresponding to the space without involving human evaluation in the first determination operation and the second determination operation.

16. The information processing device according to claim 14, the processor further configured to execute operations comprising:
acquiring a first index indicating a degree of certainty that the subject is present in the space decided by the first determination operation; and
acquiring a second index indicating a degree of certainty that the subject is present in the space decided by the second determination operation,
wherein the deciding the display projection surface further comprises deciding the display projection surface further on a basis of the first index and the second index.

17. The information processing device according to claim 16, wherein, the deciding the display projection surface further comprises:
deciding the projection surface corresponding to the space having a highest one of the degrees of certainty indicated by the first index and the second index as the display projection surface from among the first projection surface and the second projection surface.

18. The information processing device according to claim 6, wherein the first operation includes analyzing the image to determine whether a moving object is located in a front half of the region or a back half of the region as viewed from a position of capturing the image to decide the first projection surface, and the moving object is distinct from the subject.

19. The computer-readable non-transitory recording medium according to claim 7, wherein
each of the plurality of projection surfaces is associated in advance with a space occupying a certain region,
the deciding the first projection surface further comprises:
determining the space in which the subject is present by a first determination operation, and
deciding the projection surface corresponding to the determined space as the first projection surface, and
the deciding the second projection surface further comprises:
determining the space in which the subject is present by a second determination operation, and
deciding the projection surface corresponding to the determined space as the second projection surface.

20. The computer-readable non-transitory recording medium according to claim 19, wherein, the deciding the display projection surface further comprises:
determining the projection surface corresponding to the space without involving human evaluation in the first determination operation and the second determination operation.
